(19) United States
(12) Patent Application Publication
(10) Pub. No.: US 2024/0312450 A1
(43) Pub. Date: Sep. 19, 2024

(54) SYSTEMS AND METHODS FOR AUTOMATIC GENERATION OF LISTENING TEST AUDIO FROM AUDIOSCRIPT

(71) Applicant: NANJING CONCEPTIVE ARTS DIGITAL TECHNOLOGY CO., LTD., Nanjing (CN)

(72) Inventor: Xiaoyi ZHANG, Nanjing (CN)

(21) Appl. No.: 18/606,270

(22) Filed: Mar. 15, 2024

(30) Foreign Application Priority Data
Mar. 16, 2023 (CN) 202310254417.X

(51) Int. Cl. G10L 13/08; G06F 18/241; G10L 13/04; G10L 13/07

(52) U.S. Cl. CPC G10L 13/08; G06F 18/241; G10L 13/04; G10L 13/07

(57) ABSTRACT

A system, computer-readable storage medium, and computer-implemented method for automatically generating listening test audio from audioscript. The audioscript is managed by sections, and each section is parsed and section-configuration generated accordingly. All the section-configurations are composed to a configuration of the audioscript, or said, a configuration. The configuration can be transmitted to a client device such that the configuration is viewable and the parameter values in the configuration can be set/reviewed through a graphical user interface. Responsive to receiving the fulfilled configuration, each section-configuration in the configuration can be applied to the corresponding section to generate the audio and/or audio-generation-script of that section. The complete audio and/or audio-generation-script of the audioscript is generated by concatenating all the audio and/or audio-generation-script of each section.

### Technical Field

The disclosure is related to systems and methods for automatic generation of listening test audio from audioscript.

### BACKGROUND

The use of Text-to-Speech technology has greatly increased in the past few years. It has also evolved from using audio recordings of real people to text-to-speech technology for creating audio for various listening tests. However, the existing authoring tools and technologies require users to set/mark the synthesis method of each part of the text for each paragraph/sentence, to tell text-to-speech system how to generate the speech audio. This makes the production process complex and a huge amount of work. Thus, it is with respect to these considerations and others that the invention has been made.

### SUMMARY

Systems and methods are provided for automatically generating listening test audio from audioscript. An embodiment of a method for automatically generating listening test audio from audioscript comprises receiving the section-marked audioscript, managing the audioscript by sections, and each section is parsed and section-configuration generated accordingly. The method further comprises applying each section-configuration to the corresponding section, to generate the audio and/or audio-generation-script of the section. Concatenating all the audio and/or audio-generation-script of each section to generate the complete audio and/or audio-generation-script of the audioscript.

A non-transitory computer readable storage medium is further described herein, wherein the storage medium comprises instructions for which when executed cause a processing system to execute steps comprising the aforementioned method. A computer-implemented system for automatically generating listening test audio from audioscript is further described herein, wherein the system comprises one or more processors and one or more non-transitory computer readable storage mediums encoded with instructions for commanding the one or more processors to execute steps that include the aforementioned method.

### BRIEF DESCRIPTION OF THE DRAWINGS

Preferred and alternative examples of the present invention are described in detail below with reference to the following drawings. In the drawings, like reference numerals refer to like components throughout the various figures unless otherwise specified.

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows an illustration of a sample audioscript.

FIG. 2 shows a diagram illustrating of fine-tuning BERT for text classification task.

FIG. 3 is a block diagram of an example embodiment of the present invention.

FIG. 4 is a block diagram of an example computing system for implementing example embodiments of the present invention.

FIG. 5 shows a flowchart providing a process for generating corresponding configuration when receiving audioscript, according to an example embodiment.

FIG. 6 shows a flowchart providing a process for generating audio and/or audio-generation-script when receiving corresponding configuration, according to an example embodiment.

FIG. 7 shows a block diagram of Listening Audio Generation Service according to the flowchart of FIG. 5, according to an example embodiment.

FIG. 8 shows a block diagram of Listening Audio Generation Service according to the flowchart of FIG. 6, according to an example embodiment.

FIG. 9 shows an illustration of an example screenshot of a configuration.

FIG. 10 shows an illustration of an alternative example screenshot of a configuration.

FIG. 11 shows a block diagram of Section Manager, according to an example embodiment.

FIG. 12 shows a block diagram of Audioscript Parser, according to an example embodiment.

FIG. 13 shows a data diagram of the stages of an audioscript being parsed, including the audioscript being parsed to sections, and each section being parsed to sub-sections, according to an example embodiment.

FIG. 14 shows a data diagram of a section in a full parsed stage, extended according to FIG. 13, according to an example embodiment.

FIG. 15 shows a block diagram of Text Classifier Service, according to an example embodiment.

FIG. 16 shows a block diagram of Configuration Generator, according to an example embodiment.

FIG. 17 shows a block diagram of Audio Generator, according to an example embodiment.

FIG. 18 shows a block diagram of Section Audio Generator, according to an example embodiment.

FIG. 19 shows a block diagram of Questions Audio Generator, according to an example embodiment.

FIG. 20 shows a block diagram of an example computing system for implementing example embodiments of LAGS, TCS and/or PMS.

### DETAILED DESCRIPTION

Various embodiments are described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may be entirely hardware embodiments, entirely software embodiments, or embodiments combining software and hardware aspects. The following detailed description should, therefore, not be limiting.

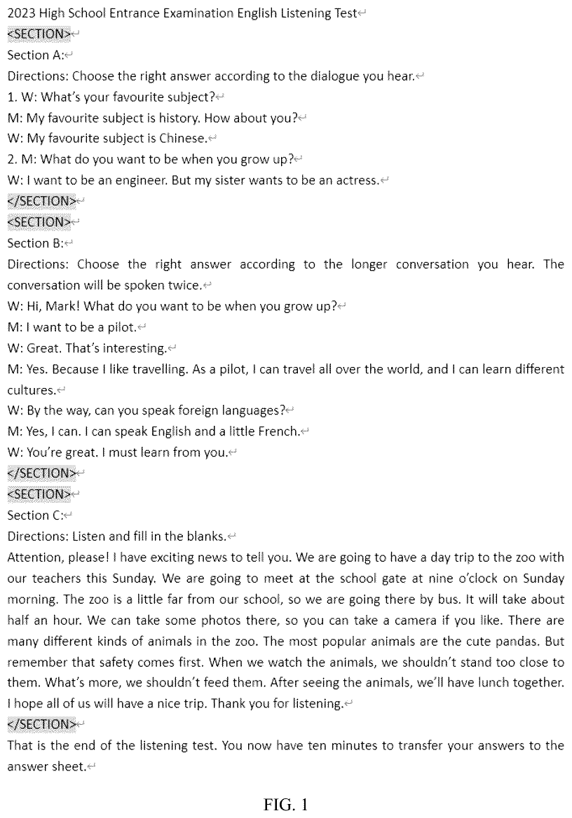

FIG. 1 is a diagram illustrating a sample audioscript for a listening test audio. The <SECTION></SECTION> is added by the user to mark a section. If all the sections in the audioscript are marked, we call such an audioscript the section-marked audioscript. Hereinafter, unless otherwise specified, audioscript means section-marked audioscript. In various embodiments, the form of marking on audioscript is not limited. In some embodiments, marking the sections by content format. For example, at the beginning of each section, there is a “heading” format, using bold fonts, enlarged fonts, etc., and the rest of the content is in a normal format. In some embodiments, marking the sections by blank lines. For example, there are blank lines between each section, and no blank lines between other content. In other embodiments, the sections of an audioscript may be identified by an AI program/model, and marked in a JSON structure.

In a section, there are generally two types of content, most notably is a set of questions, which are usually preceded by directions for that set of questions. We call the directions and the following questions a pair of directions and questions. Sometimes, in a section, there may be multiple sets of questions, and accordingly there will be multiple directions, that is, there are multiple pairs of directions and questions.

Since each section is a relatively independent logical unit in the audioscript of a listening test, it has integrity and internal consistency. For example, all the directions content in a section will be spoken by the same voice, and the same role indicator in each question also corresponds to a same voice, and the silence time for students to answer the question after each question is played, should also be the same within a section. Therefore, parameters can be defined in terms of sections, which facilitates automatic audio generation. Although the parameter values are different between sections, the parameter items remain the same. We call all the parameter items for a section as the section-configuration. We take the parameters involved in the directions content as the first type of configuration. Specifically, it includes: the synthesis mode Bh of the paragraph text (the synthesis mode includes the synthesis voice V and its speaking rate VR, and in various embodiments, may also include pitch, volume, emotion, etc.), the silence time H1 between each paragraph, and the silence time H2 at the end of the text in the directions. Each parameter is a kind of data with a Key-Value structure. For example, the synthesis mode of paragraph text is a parameter in the configuration, and its corresponding parameter value is Bh.

And, we take the parameters involved in the questions content as the second type of configuration. Specifically, it includes: the synthesis mode Bn of the question number, the corresponding synthesis mode Bd of each role indicator in a conversation. If there are no role indicators in the questions content (i.e., the question does not contain conversation), the synthesis mode Bc of the question content, the silence time Q1 after the question number, the silence time Q2 between a conversation, and silence time Q3 after the question (used for the students to answer that question); If each question need to be played more than once, there will be a parameter of repeat count C, and a silence time Q4 in between when the question is repeated. In various embodiments, the cue tone LS may be played before the question (e.g., play a “ding-dong” sound to remind students to pay attention to the question), and the cue tone LB may be played when the question is repeated (the tone is changed to a shorter sound, which is different from the first time it was played, so that students can tell that the question has begun to be repeated).

Therefore, distinguishing between directions content and questions content is key to further parsing and processing each section. In the present invention, the language model is used to classify each paragraph in a section into two categories: “directions” and “questions”. In this way, it is possible to handle both types of paragraphs in a targeted manner. The more detailed description of the language model will be presented later.

In particular, some parameter values may already be present in the section content. For example, in the content of “Directions”, there may be indicative content such as “Each question will be played N times”, which means that each question along with this “Directions” need to be played N times. And this value N is the parameter value of repeat count C. In another example, there may be “(00′03″)” at the end of some paragraphs, indicating that the corresponding position needs to pause for 3 seconds. The value 3 is the parameter value of the silence time (in seconds).

Therefore, in addition to setting each parameter through the user interface by user, it is also possible to extract these preferred parameter values from the section text. After the preferred values are extracted, we can use these values to override the default values corresponding to the parameters. Users can further choose whether to prioritize the parameters set by user (ignoring the parameters extracted from the section text) or the parameters extracted from the section text (adapt to section text).

In the present invention, the combination of the first type of configuration corresponding to the “Directions” content and the second type of configuration corresponding to the “Questions” content is called a “section-configuration”. The list of section-configurations corresponding to all sections in the audioscript is called “audioscript-configuration”, which is simply called configuration.

The configuration can be saved in a non-transitory computer readable storage medium and used as a reference configuration when you produce audio for a listening test the next time. This eliminates the need to refill the parameter values every time. To better achieve this, we can extract features from the audioscript and use them as the tag of the audioscript and the tag of the corresponding configuration. This makes it possible to determine whether a previously saved configuration is suitable for this current audioscript based on the tag. The tag is also a type of data with a key-value structure. For example, one of the common tags may be the language of listening test (English listening test, Japanese listening test, Spanish listening test, etc.). Expressing this tag in a key-value way, that is, Language of Listening Test =English. There may be other tags, such as the type of listening test (Grade 10 Listening test, High School Entrance Listening test, IELTS Listening, etc.), as well as the number of sections, etc. There may be differences in the way each feature is extracted. For example, extracting the language of the listening test can generally be achieved by identifying the language of the text of the “Questions”. From the title of an audioscript like “2023 High School Entrance Examination English Listening Test”, the test type “High School Entrance Examination” can be extracted. Expressing this tag in a key-value way, that is, Type of Test=High School Entrance Examination.

In a plurality of steps in the present invention, the key information satisfying a specified pattern needs to be extracted from the paragraph text. In the process of parsing section content, parsing a paragraph into question number, role indicator, and question content is also a form of pattern matching. In various embodiments, the use of regular expression may be preferred as an implementation of defining and matching patterns in text/strings.

Since the audioscript are natural language texts with no fixed form for their content or format, there may be multiple patterns for each purpose in a pattern group to accommodate the multiple forms that may appear in different audioscripts. For ease of description, we name the patterns in a pattern group according to their purpose, for example, the patterns used to extract the silence time is called “silence time extraction patterns”. And each pattern in a pattern group can be implemented as a regular expression.

Each pattern group has a name and its purpose. And the pattern groups are categorized according to their scope. For example, the “silence time extraction patterns” needs to be matched in both the “Directions” content and the “Questions” content in a section, so such pattern group belongs to “common patterns”. And for an indicative content of how many times each question will be played will only appear in the Directions content, and the “repeat count extraction patterns” will only be matched in Directions content, so the “repeat count extraction patterns” belong to “Directions patterns”. And in the meanwhile, “question parsing patterns” belongs to “Questions patterns”. The pattern groups used in the present invention, and how they are organized, are illustrated in Table 1 below.

TABLE 1

| Name | Purpose | Patterns List/Regular Expressions List | Category |
|---|---|---|---|
| Silence | To extract | \(.*([0-9]+)′([0-9]+)″\)$ | Common |
| time | silence time | | Patterns |
| extraction | values in | | |
| patterns | paragraphs | | |
| Repeat | To extract | spoken (two\|three\|four\|five) times | Directions |
| count | repeat count | spoken (only) {0, 1} (once\|twice) | Patterns |
| extraction | values in | | |
| patterns | Directions | | |
| Grade | To extract | (fourth\|fifth\|sixth\|seventh\|eighth\|ninth\|tenth) | Directions |
| of test | grade | grade | Patterns |
| extraction | values of the | | |
| patterns | test in | | |
| | Directions | | |
| Question | To divide and | ([0-9]+[.,]\s)?([MW]:)?(.*) | Questions |
| parsing | extract | ([0-9]+[.,]\s)?((Mike\|Mary):)?(.*) | Patterns |
| patterns | question | | |
| | number, role | | |
| | indicator and | | |
| | question | | |
| | content from | | |
| | each | | |
| | paragraph in | | |
| | Questions | | |

When a pattern group is used to extract information from a paragraph, or to parse a paragraph into parts, each pattern in the pattern group is used to match the corresponding text in turn, until a pattern matches the corresponding text, or until none of them match, indicating that the corresponding information/content/form is not present in the text.

As the system of the present invention continues to evolve in practice, the system administrator can add more patterns to the pattern groups defined above, so that various forms of audioscript can be supported without modifying the system itself.

The present invention provides a computer-implemented method for automatically generating listening test audio from audioscript, comprising:
receiving the section-marked audioscript, managing the audioscript by sections, and parsing each section to a parsed state;
processing for each section, generating the section-configuration according to the corresponding section, and combining all section-configurations into an audioscript configuration, or said, a configuration;
transmitting to a client device associated with a user, a graphical user interface (GUI) configured to display the configuration for the user to set/review/confirm the parameter values;
receiving the fulfilled/confirmed configuration, applying each section-configuration in the configuration to the corresponding section, to generate the audio and/or audio-generation-script of the section; and
concatenating all the audio and/or audio-generation-script of sections to generate the complete audio and/or audio-generation-script of the audioscript.

For parsing each section to a parsed state, further comprising:
classifying by the language model, each paragraph in section is divided into two categories: Directions and Questions, by which split the section into directions content and questions content, for each paragraph in questions content, parsed further to question number, role indicator and question content (a specific paragraph may only have one or more of these three parts) by pattern matching.

Pattern matching can be implemented using a regular expression engine.

For generating the section-configuration according to the corresponding section, further comprising:
generating the first type of configuration from directions content in the section, and initializing the parameter values to default values. Generating the second type of configuration from questions content in the section, and initializing the parameter values to default values. Combining the first type of configuration and the second type of configuration into a section-configuration.

For the first type of configuration, includes:
the synthesis mode Bh of the paragraph text (the synthesis mode includes the synthesis voice V and its speaking rate VR, in various embodiments, may also include pitch, volume, emotion, etc.), the silence time H1 between each paragraph and the silence time H2 at the end of the text in the directions.

For the second type of configuration, includes:
the synthesis mode Bn for the question number, the corresponding synthesis mode Bd for each role indicator in a conversation. If there are no role indicators in the questions content (i.e., the question does not contain a conversation), the synthesis mode Bc for the question content, the silence time Q1 after the question number, the silence time Q2 between a conversation, and the silence time Q3 after the question (used for the students to answer that question); If each question needs to be played more than once, there is a parameter of repeat count C, and the silence time Q4 in between when the question is repeated.

In various embodiments, the second type of configuration may further include:
a cue tone LS before the question begins and a cue tone LB when the question is repeated.

For generating the section-configuration according to the corresponding section, further comprising:
extracting visible parameter values from the paragraphs in directions content and questions content in section as preferred parameter values by pattern matching to override default values.

For applying each section-configuration in the configuration to the corresponding section, to generate the audio and/or audio-generation-script of the section, further comprising:
generating audio and/or audio-generation-script from directions content by applying the first type of configuration to each paragraph in the corresponding directions content;
generating audio and/or audio-generation-script from questions content by applying the second type of configuration to each part of a paragraph in the corresponding questions content; and
concatenating all of the audio and/or audio-generation-script of the directions content and the questions content to generate the audio and/or audio-generation-script of the section.

The method further comprising:
responsive to receiving the fulfilled/confirmed configuration, saving the configuration to a non-transitory computer readable storage medium, for future reuse.

The method further comprising:
responsive to the configuration being generated, extracting features from audioscript, as the tags of the audioscript, and as the tags of the configuration corresponding to the audioscript;
responsive to receiving the fulfilled/confirmed configuration, tags saved along with the configuration as additional information and/or metadata of the configuration;
responsive to tags being generated, use tags as the key to query whether the previously saved configurations match the current audioscript, and use the matching configurations as the reference configurations; and
responsive to a reference configuration being selected, replacing the parameter values in the current configuration with the values from the user-selected preferred reference configuration for fast filling.

The tags include and not limited to:
the tag of the language of listening test, by identifying the language of the text of the questions;
the tag of type of test, by extracting value from directions content, by matching the specified patterns.

The brief description of the invention is intended to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detail description this is presented later.

### EXAMPLES

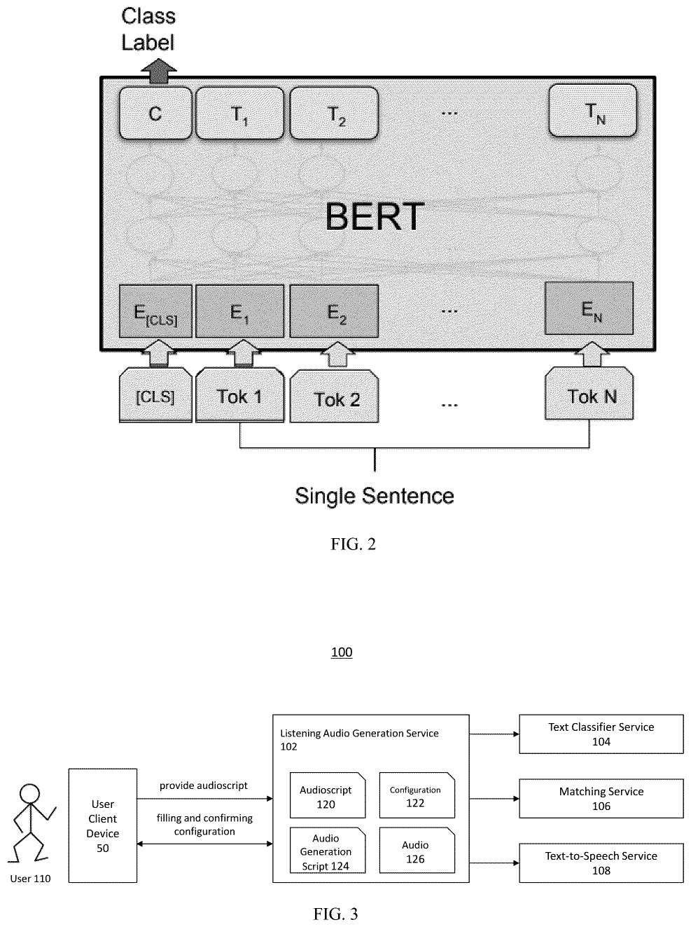

As mentioned above, the language model is used to perform the binary classification task, to classify each paragraph in a section into two categories: directions and questions. In an embodiment, the pre-trained BERT model (https://arxiv.org/abs/1810.04805) is used, and fine-tuned by customized dataset built from annotated text data in audioscripts. The model structure of the BERT language model suitable for fine-tuning binary classification tasks is illustrated in FIG. 2.

As described in the paper of BERT, the training data for fine-turning the BERT for text classification task is a degenerate text-Ø pair. The customized datasets are built according to the language of the listening test, such as Japanese listening test dataset, Spanish listening test dataset, etc. This article takes the English listening test dataset as an example to illustrate the form of the customized dataset, as shown in Table 2 below. The dataset actually has only two columns, category as the label/[CLS] for BERT, and paragraph as the text. Category has two values: Directions: indicates that the data is “Directions”, or Not Directions: indicates that the data is not directions. In order to better manage the data, each row of data has an X-Y serial number, which indicates that the row of data comes from the Y-th row/paragraph of the audioscript X. This serial number is for management purposes only and is not used by the model.

TABLE 2

| | category | Text/paragraph |
|---|---|---|
| 0-0 | Directions | listening comprehension |
| 0-1 | Directions | directions: in this section, you will hear three news |
| | | reports. at the end of each news report, you will |
| | | hear two or three questions. both the news report |
| | | and the questions will be spoken only once. after |
| | | you hear a question, you must choose the best answer |
| | | from the four choices marked a), b), b) and d), then |
| | | mark the corresponding letter on answer sheet |
| | | 1 with a single line through the centre. |
| 0-2 | Not | morocco is responding to increasing energy demands |
| | Directions | by setting up one of the largest solar plants |
| | | in the world. |

In order to be compatible with the pre-trained language model, the data used for fine-tuning needs to be transformed accordingly, which is called preprocessing. The preprocessing action for the English listening test dataset is to lower-case the text data, i.e. to normalize the text to lowercase, for example:

Directions: In this section, you will hear three news reports. At the end of each news report, you will hear two or three questions. Both the news report and the questions will be spoken only once. After you hear a question, you must choose the best answer from the four choices marked A), B), C) and D). Then mark the corresponding letter on Answer Sheet 1 with a single line through the centre.

After preprocessing:
directions: in this section, you will hear three news reports. at the end of each news report, you will hear two or three questions. both the news report and the questions will be spoken only once. after you hear a question, you must choose the best answer from the four choices marked a), b), b) and d), then mark the corresponding letter on answer sheet 1 with a single line through the centre.

In general, a dataset of about 1,000 audioscripts for a given language of listening test can be used as a dataset to achieve sufficient accuracy for commercial purposes.

In the present invention, each paragraph in a section of the audioscript is submitted to this language model for text classification. Specifically, the text of each paragraph in audioscript is first “preprocessed” and then fed to the model as the input data. After classification by the model, the output result is “Directions”, which means that the input paragraph is “Directions”, or “Not Directions”, which means that the input paragraph is “Questions”. In this way, each paragraph is divided into two categories: “Directions” and “Questions”. This identifies unstructured audioscript as structured content with clear meaning, bringing prerequisites for subsequent automated processing.

### Example Computing System Implementation

FIG. 3 is a block diagram of an example system of this invention. In particular, FIG. 3 depicts a system 100 to generate the listening test audio from audioscript. In the illustrated scenario, the user 110 operates a user client device 50 in order to provide (e.g., upload, transmit) an electronic document of audioscript 120 to the Listening Audio Generation Service (LAGS) 102. After parsing and processing on the audioscript, the corresponding configuration 122 is generated by LAGS 102. In parsing and processing on the audioscript, LAGS 102 may call Text Classifier Service (TCS) 104 to distinguish each paragraph in the section into two categories: directions and questions. In this way, LAGS 102 is able to handle both types of paragraphs in a targeted manner. In parsing and processing on the audioscript, LAGS 102 may call Pattern Matching Service (PMS) 106 to parse each paragraph in questions into question number, role indicator, and question content. In generating configuration, LAGS 102 may call PMS 106 to extract tags and preferred parameter values from sections.

The LAGS 102 provides the configuration (or a representation thereof) to the user client device 50 for presentation. The user 110 operates a Web browser or other client module (e.g., mobile app) executing on the user client device 50 to fulfill and/or review the configuration 122. When the configuration 122 has been fulfilled and/or reviewed by the user 110, the LAGS 102 applies the configuration 122 to the audioscript 120 section by section to generate the audio 126 and/or audio-generation-script 124. In generating the audio 126, LAGS 102 may call Text-to-Speech Service 108 to convert text to speech audio.

Once the audio 126 and/or the audio-generation-script 124 have been generated, the LAGS 102 may transmit a URL, link, or other identifier of the audio 126 or the audio-generation-script 124 to the user client device 50 as a result.

### Example Processes

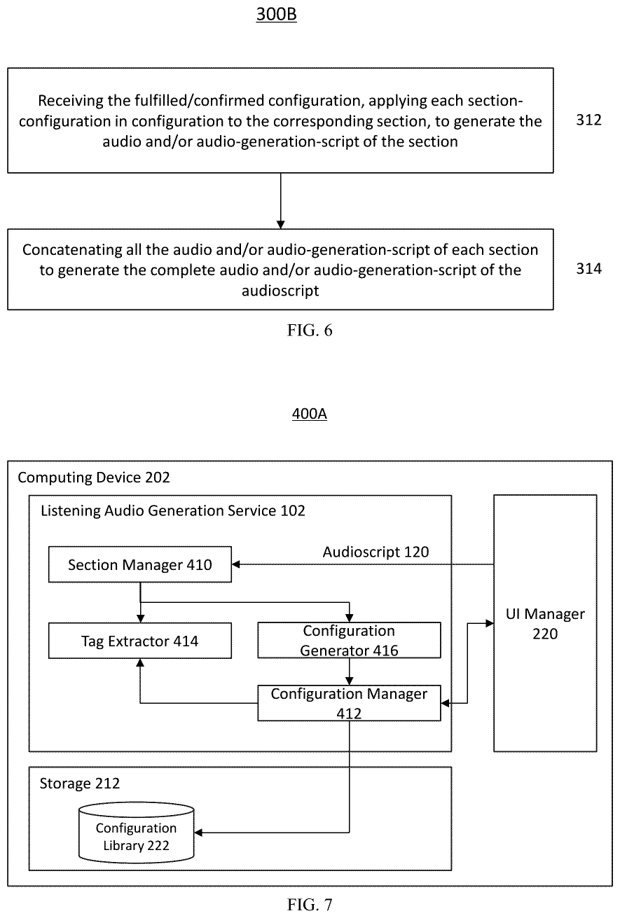

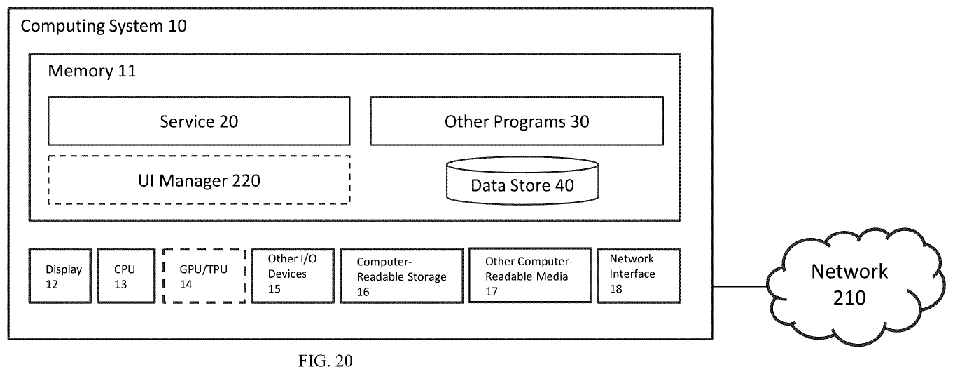

The operation of certain aspects of the invention will now be described with respect to FIGS.5-6. In at least one of various embodiments, processes 300A, 300B of FIGS.5-6, respectively, may be implemented by and/or executed on one or more computers, such as computing system 10 of FIG. 20 or other network computers or devices. Additionally, various embodiments described herein can be implemented in a system such as system 100 of FIG. 3.

FIG. 5 illustrates a logical flow diagram generally showing one embodiment of an overview process for receiving, parsing and processing audioscript in an audioscript parsing and audio generation service (e.g., LAGS 102 in FIG. 3) to generate corresponding configuration.

Process 300A begins at block 302, where an audioscript 120 may be received by LAGS 102. In block 302, LAGS 102 parses the audioscript 120 into multiple sections, and manages the sections as an array of sections 1004, according to FIG. 13. LAGS 102 continues to parse and process each section node 1020 to a parsed state. In parsing and processing on each section node 1020, LAGS 102 may call TCS 104 to distinguish each paragraph in the section node into two categories: directions and questions. In this way, each section node 1020 in the array of sections 1004 will be parsed into multiple sub-section nodes, each sub-section node 1022 has a type attribute, including directions type and questions type. For convenience, we call a sub-section node of type directions as directions node 1028, according to FIG. 14, and we call a sub-section node of type questions as questions node 1024. LAGS 102 further parses each sub-section node, and for questions node 1024, LAGS 102 may call PMS 106 to parse each paragraph in questions node 1024 into question number, role indicator, and question content. With question number, LAGS 102 can split the questions node 1024 into multiple question nodes, and each question node 1026 includes one question. In this way, each section node 1020 will eventually be fully parsed, that is, each section node 1020 is in a parsed state.

Process 300A proceeds to block 304. In block 304, for each section node in the array of sections is analyzed to generate the corresponding section-configuration, and the preferred parameter values are extracted from the section node, to override the default parameter values. All the section-configurations are composed into one audioscript configuration, that is, the configuration 122.

Process 300A proceeds to block 306. In block 306, features are extracted from the array of sections and used as the tags of the audioscript and the tags of the configuration.

Process 300A proceeds to block 308. In block 308, the tags of the audioscript are used as the key to query the previously saved configurations. If matching configurations exist, these configurations are used as the reference configurations.

Process 300A proceeds to block 310. In block 310, the configuration generated in 304 will be displayed on the user interface for the user to review and/or set the parameter values. In some embodiments, the reference configurations queried in block 308 may be displayed on the user interface so that the user can select a preferred reference configuration and use the parameter values of the reference configuration to replace the current configuration for fast filling. In some embodiments, the tags of the configuration may also be displayed on the user interface, and the user can add new tags and/or edit, delete existing tags.

FIG. 6 illustrates a logical flow diagram generally showing one embodiment of an overview process after user fulfilled and/or reviewed the configuration and the audioscript parsing and audio generation service (e.g., LAGS 102 in FIG. 3) applies the configuration to the corresponding section to generate the audio and/or audio-generation-script of the section. And concatenating all the audio and/or audio-generation-script of each section to generate the complete audio and/or audio-generation-script of the audioscript.

Process 300B begins at block 312, where a fulfilled configuration 122 may be received by LAGS 102. In block 312, LAGS 102 saves the configuration to storage for future reuse (as a reference configuration). When a configuration is saved, additional information and/or metadata, such as the title of the configuration, tags, are also saved. After the configuration saved, LAGS 102 applies the corresponding section-configuration in the configuration to each section node in the array of sections to generate the audio and/or audio-generation-script of the section. And the section nodes in the array of sections are already in the parsed state, referring to 1008. When processing a section node, each sub-section node in the section node will be processed. If a sub-section node is a directions node, the corresponding section-configuration (the first type of configuration in the section-configuration, more precisely) will be applied to each paragraph in the directions node to generate the audio and/or audio-generation-script of the directions node. If a sub-section node is a questions node, each question node in the questions node will be processed. When processing a question node, the corresponding section-configuration (the second type of configuration in the section-configuration, more precisely) will be applied to each part of the question node to generate the audio and/or audio-generation-script of the question node. All audio and/or audio-generation-scripts corresponding to question nodes will be concatenated to generate the audio and/or audio-generation-script of the questions node. All audio and/or audio-generation-scripts corresponding to the directions node and the questions node will be concatenated to generate the audio and/or audio-generation-script of the section node.

Process 300B proceeds to block 314. In block 314, LAGS 102 concatenates all the audio and/or audio-generation-scripts of each section to generate the complete audio and/or audio-generation-script corresponding to the audioscript. Once the audio 126 and/or the audio-generation-script 124 have been generated, the LAGS 102 may transmit a URL, link, or other identifier of the audio 126 or the audio-generation-script 124 to the user client device 50 as a result.

### Example Computing System Implementation

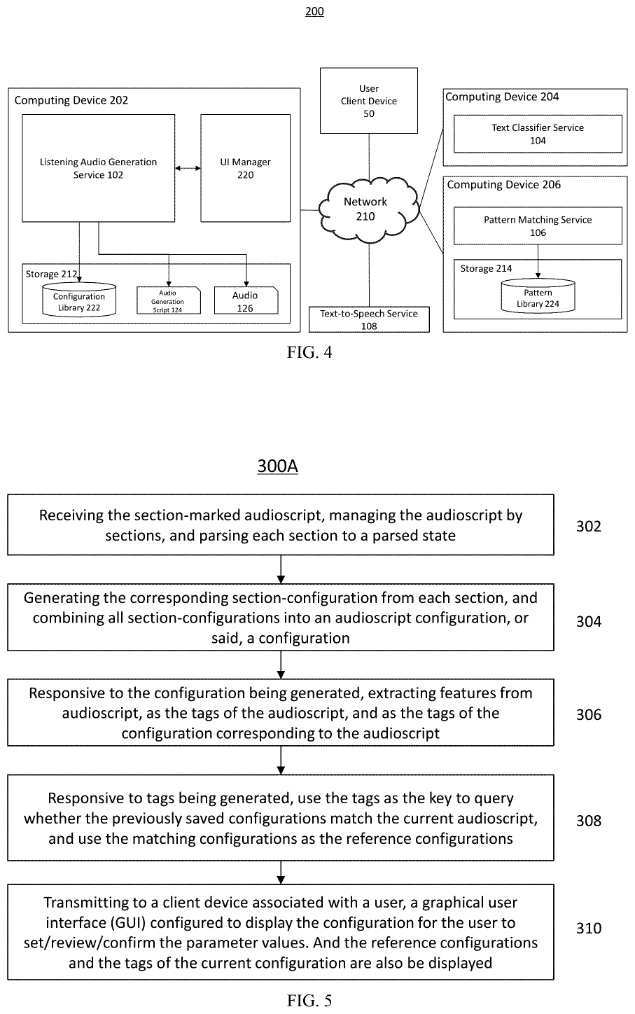

Embodiments may be implemented in various environments. For instance, FIG. 4 shows a block diagram of computing system 200. The computing system 200 includes a first computing device 202, a second computing device 204, and a third computing device 206. A network 210 communicatively couples user-facing computing device 202 with backend computing device 204, 206 and Text-to-Speech service 108 a public service. Computing device 202 includes listening audio generation service 102, UI Manager 220 and storage 212. Computing device 204 includes text classifier service 104. Computing device 206 includes pattern matching service 106 and storage 214. Computing system 200 is further described as follows.

Computing device 202, 204, and 206 may each be any type of stationary or mobile computing device, including a stationary computing device such as a desktop computer or a server device, or a mobile computer or mobile computing device (e.g., a laptop computer, a notebook computer, a tablet computer), a mobile phone (e.g., a smart phone such as an Apple iphone, etc.)

Each of computing device 202, 204, and 206 may include at least one network interface that enables communications over network 210.

Referring back to FIG. 5, FIG. 5 shows a flowchart 300A provides a process for generating a configuration from audioscript. According to an example embodiment, flowchart 300A is described as follows with respect to FIG. 7.

In an embodiment, according to block 302, Section Manager 410 is configured to parse the audioscript 120 into an array of sections 1004. The Section Manager 410 receives the audioscript 120 from UI Manager 220, parses the audioscript 120 into multiple sections, and manages the sections as an array of sections 1004. The Section Manager 410 continues to parse and process each section node 1020 to a parsed state.

In an embodiment, according to block 304, Configuration Generator 416 is configured to generate section-configuration according each section. The Configuration Generator 416 analyzes each section node in the array of sections to generate the corresponding section-configuration. In some embodiments, the Configuration Generator 416 extracts preferred parameter values from the corresponding section node to override the default values initialized. The Configuration Generator 416 sends all the section-configurations to Configuration Manager 412. The Configuration Manager 412 composes all the section-configurations into one audioscript configuration, that is, the configuration 122.

In an embodiment, according to block 306, Tag Extractor 414 is configured to extract features from the array of sections. The Tag Extractor 414 extracts features from the array of sections, and uses them as tags for the audioscript. Triggered by the generation of the tags, Configuration Manager 412 reads the tags of the audioscript from Tag Extractor 414 and uses the tags as the tags of the configuration.

In an embodiment, according to block 308, Configuration Manager 412 uses the tags of the audioscript as the key to query the previously saved configurations from Configuration Library 222. If matching configurations exist, Configuration Manager 412 uses them as reference configurations. In an embodiment, the Configuration Library 222 is on Storage 212.

In an embodiment, according to block 310, Configuration Manager 412 provides the configuration (or a representation thereof) to UI Manager 220 for presentation. In addition, the reference configurations, and the tags of configuration are also provided to UI Manager 220. In some embodiments, UI Manager 220 may display the list of reference configurations in a drop-down list. If the user selects a preferred reference configuration, the parameter values of the reference configuration will replace the parameter values in current configuration for fast filling. In some embodiments, UI Manager 220 may display the tags of the configuration for user to edit or delete, and it is possible to add customized tags via an add button in the UI.

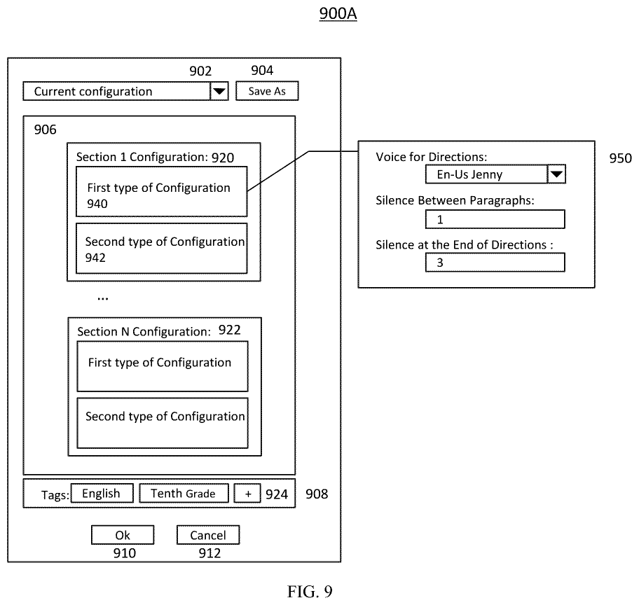

FIG. 9 is an example of a user interface. The configuration provided by Configuration Manager 412 to UI Manager 220 will be displayed on the user interface as current configuration, i.e. in the 906 area, and the configuration contains multiple section-configurations. Each section-configuration includes a first type configuration 940 and a second type configuration 942. For example, referring to the sample user interface 950 of a first type configuration, it includes the synthesis mode of the paragraphs in the directions content (the synthesis mode further includes more parameters in various embodiments, the name of synthesis voice, for example), the silence time between paragraphs, and the silence time at the end of directions content. Users can set and/or review each parameter values via the user interface. In some embodiments, tags of the configuration are shown in area 908, including the tag of the language of listening test (English listening test, Japanese listening test, Spanish listening test, etc.), and the tag of the type of listening test (Grade 10 listening test, high school entrance exam, IELTS listening test, etc.). In some embodiments, the user can edit or delete the existing tags, and it is possible to add customized tags via the “+” button 924. In some embodiments, the user can use the drop-down list 902 to select a reference configuration and use the parameter values of the reference configuration to replace the corresponding parameter values in the current configuration for fast filling. In some embodiments, the user can click the Save As button 904 to save the current configuration for future reuse. When a configuration is saved, additional information and/or metadata, such as tags, the title of the configuration provided by the user, are also saved.

When the user clicks the Save As button 904, UI Manager 220 will notify Configuration Manager 412, which will save the current configuration to Configuration Library 222 located on Storage 212. It is also possible to provide a user interface to manage all the saved configurations, including viewing the configurations and deleting those that are no longer needed. Accordingly, Configuration Library 222 has the function of deleting specified configurations.

In an embodiment, FIG. 11 shows a block diagram of Section Manager 410. In Section Manager 410, Audioscript Parser 502 receives an audioscript 120, parses it into multiple sections, manages it as an array of sections, and saves the array of sections in Data Store 504.

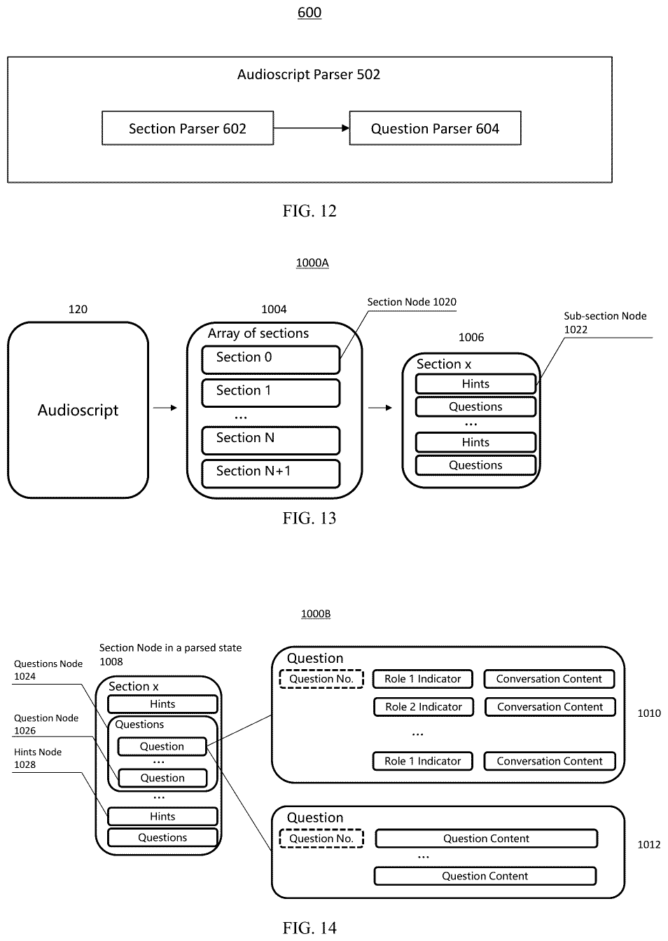

In an embodiment, FIG. 12 shows a block diagram of Audioscript Parser 502. To better illustrate the parsing process on audioscript, a Data structure diagram of FIG. 13 is provided. In an embodiment, Section Parser 602 receives an audioscript 120. In a practical example, an audioscript may contain multiple sections such as Section 1 and Section 2, which have been marked by user. Additionally, there may be extra content such as the title of the listening test before Section 1, for example, “Welcome to Shanghai High School Entrance Examination”. In a meanwhile, after the last section, there may be “That is the end of the listening test. You now have ten minutes to transfer your answers to the answer sheet.” Therefore, Section Parser 602 automatically marks the contents (if it exists) before the first section as a Section 0, and the contents (if it exists) after the last section, as a Section N+1. At this stage, audioscript 120 is organized into sections, or said an array of sections 1004, and each section in the array of sections is called a section node 1020.

In an embodiment, Section Parser 602 walks through section 1 to section N, and calls Text Classifier Service 104 located in Computing Device 204 to distinguish the paragraphs in each section into two categories: Directions and Questions, that is, for each section node from section node 1 to section node N, provides each paragraph content in a section node to TCS 104, according to the classification results, if the return value is “Directions”, the corresponding paragraph will be treated as directions content, if the return value is “Not Directions”, the corresponding paragraph will be treated as questions content. For section 0 and section N+1 do not contain any questions content, all paragraphs in these two sections are treated as directions content. In this way, each section node is divided into multiple sub-section nodes, and the type of each sub-section node 1022 has been determined, in directions type or questions type, and for section node 0 and section node N+1, each of them only has one sub-section node, and the type of sub-section node is assigned to directions type with no condition. In data view, each section node looks like 1006 at this stage.

In an embodiment, Section Parser 602 continues to parse each section node. For each sub-section node in a section node, if the sub-section node is a questions node, the Section Parser 602 provides it to Question Parser 604, which splits the questions node 1024 into one or more question node 1026. In detail, Question Parser 604 may call PMS 106 on Computing Device 106 to parse each paragraph in questions node 1024, and specifies parsing the paragraph by “question parser patterns”. In an embodiment, PMS 106 may be implemented by a regular expression engine. PMS 106 retrieves the “question parser patterns” from Pattern Library 224 on Storage 214. In an embodiment, the “question parser patterns” is a group of predefined regular expressions. With the matching and/or capturing group function of the regular expression, Question Parser 604 splits each paragraph into three parts: question number, role indicator, and question content. Depending on the content of a paragraph, some of the parts may not exist. For example, some paragraphs may have no question number and no role indicator, and some paragraphs may have only question number. By question number, the range of one question can be determined, that is, the range of a single question is started from the current question number and ended before the next question number (or at the end of the sub-section node, if the next question number does not exist). In an example, if role indicators exist, this means that the question is in the form of a conversation and the parsed question node looks like 1010, otherwise the question does not contain a conversation and the parsed question node looks like 1012. The question number in 1010/1012 is in a dotted box, indicating that this part may not exist, and when the question number does not exist, a questions node contains only one question node. At this stage, each section node 1020 is fully parsed, that is, each section node 1020 is in a parsed state, referring to 1008 in FIG. 14.

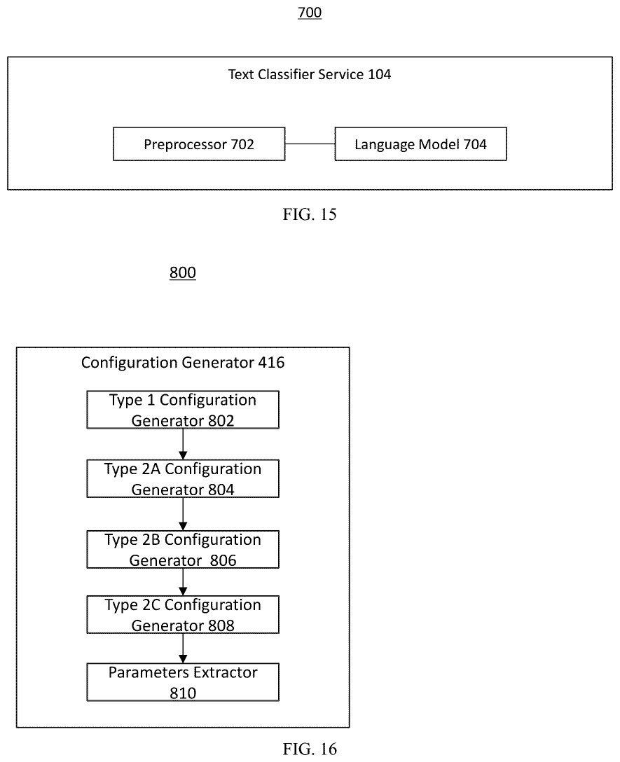

In an embodiment, FIG. 15 shows a block diagram of TCS 104. TCS 104 includes Preprocessor 702 and Language Model 704. Section Parser 602, described above, may call TCS 104 with each paragraph, and TCS 104 hands over the paragraph to the Preprocessor 702 for preprocessing. For example, if the paragraph is in English, the Preprocessor 702 will perform a lower-case operation on the text, that is, convert all the paragraph text to lower-case, which is kept the same as the preprocessing method on the data to fine-tune the model. After the paragraph is preprocessed by Preprocessor 702, the normalized text of paragraph is ready for Language Model 704 as the input to do the classification, and the Language Model 704 will give the classification result of “Directions” or “Not Directions”.

In an embodiment, referring back to FIG. 7, Tag Extractor 414 may extract specified features from sections to generate tags. Two examples are given to illustrate the working process of Tag Extractor 414. For the first example, Tag Extractor 414 will extract the tag of the language of listening test. In an embodiment, Tag Extractor 414 walks through the array of sections to obtain the first section node with questions node in it, and obtains the first question node in questions node, then the language of the listening test can be determined according to the language of the text in the question node. The determined language will be used as the value of the tag (e.g., English, Japanese, Spanish and so on); For the second example, Tag Extractor 414 will extract the tag of the type of listening test. In an embodiment, Tag Extractor 414 obtains the directions node in the first section node (which may be Section 0 or Section 1), calls the PMS 106 located on Computing Device 106 with each paragraph in the directions node, and specifies using “listening grade extraction patterns”. PMS 106 retrieves the corresponding pattern group from Pattern Library 224 on Storage 214 and matches each paragraph to the patterns in the corresponding pattern group. PMS 106 returns the matching result to Tag Extractor 414. Depending on the matching result, if match result is not empty, Tag Extractor 414 will use the extracted value as the value of tag (e.g. Tenth Grade, High School Entrance and so on), if the match result is empty, Tag Extractor 414 will not add the tag of the type of listening test.

In an embodiment, FIG. 16 shows a block diagram of Configuration Generator 416. Configuration Generator 416 is configured to generate the corresponding section-configuration for each section. In an embodiment, for each section, Configuration Generator 416 creates the corresponding empty section-configuration. If there has directions nodes in section node, the Type 1 Configuration Generator 802 is used to add parameters in the first type of configuration to the section-configuration and the corresponding parameter values are initialized to their default values.

If there are questions node in section node, the parameters in the second type of configuration should be added to the section-configuration, and each parameter value will be initialized to its default value. The parameters in the second type of configuration are more complicated, and can be further categorized into type 2A configuration items, type 2B configuration items, and type 2C configuration items. The so-called type 2A configuration items include conversation role pairs/groups that appear in the question nodes in this section. As an example, Question 1 contains a conversation that may contain two characters, W and M, where W represents a female character and M represents a male character, and then we call W and M a pair of characters, or a role pair. For other examples, there may be multiple characters in a question, e.g. Mike, Mary, Tom, and when there are more than two characters, we call it a role group. On a technical level, there is no significant difference between a conversation containing two or more characters, and the more general case of containing two characters in a conversation will be discussed hereinafter.

In an embodiment, Type 2A Configuration Generator 804 processes each question node in questions node, extracts the role pair based on the role indicators appearing in the question node, and adds it to the type 2A configuration of the current section-configuration. If the same role pair already exists, there is no need to add it repeatedly. Therefore, there may be 0 (the questions in this section do not contain conversation), 1, or more role pairs in a type 2A configuration.

The so-called type 2B configuration includes the repeat count C, if each question needs to be played more than once in the current section, and the silence time G after each question (used for students to answer that question); and the type 2C configuration items, which are other configuration items, besides type 2A configuration and type 2B configuration, including: the synthesis mode Bn of the question number, the synthesis mode Bc of the question content if there is no role indicators in the question (i.e., the question does not contain conversation), the silence time Q1 after the question number, the silence time Q2 between a conversation, etc.;

In an embodiment, if there has questions node in section node, Type 2B Configuration Generator 806 will add parameters of type 2B configuration to the section-configuration and initialize the parameter values to their default values.

In an embodiment, if there has questions node in section node, Type 2C Configuration Generator 808 will add parameters of type 2C configuration to the section-configuration and initialize the parameter values to their default values.

In an embodiment, Parameters Extractor 810 attempts to extract preferred parameter values from each paragraph of the section. As an example, Parameters Extractor 810 calls PMS 106 on Computing Device 206 with each paragraph in directions node, and specifies using “repeat count extraction patterns”. PMS 106 retrieves the corresponding pattern group from Pattern Library 224 on Storage 214 and matches each paragraph to the patterns in the corresponding pattern group. PMS 106 returns the matching result to Parameters Extractor 810. Depending on the matching result, if match result is not empty, Parameters Extractor 810 will use the extracted value as the preferred parameter value of repeat count to override the default value.

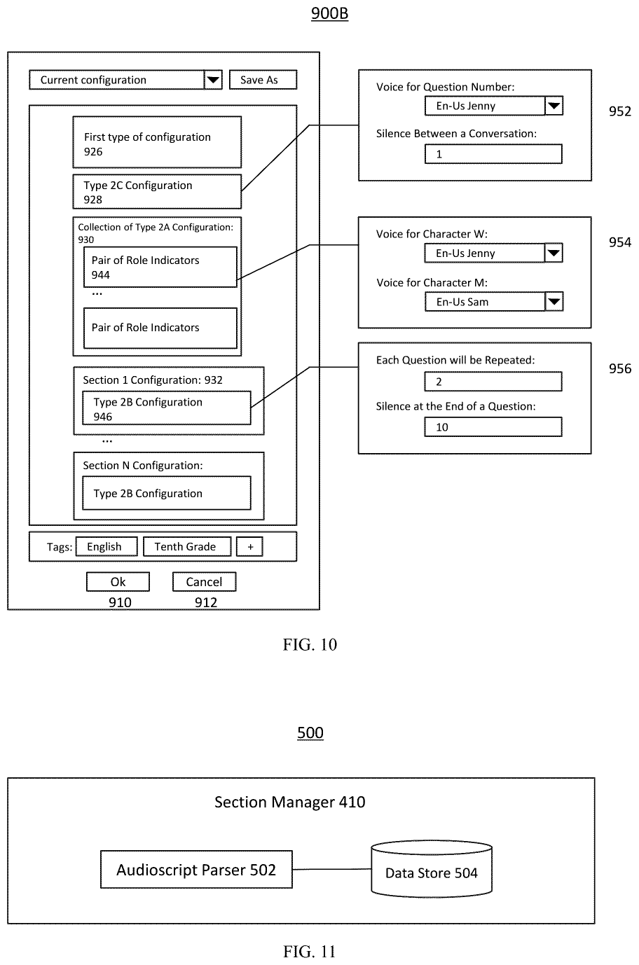

In a real listening test, the directions in the audioscript are usually read/synthesized by the same person/voice, so as an alternative user interface implementation, refer to FIG. 10, the first type of configuration in each section-configuration, can be unified into one without the need to provide the configuration for each section as in FIG. 9. Similarly, the Type 2C configuration can also be unified into one, the user interface implementation of Type 2C configuration, as an example, may look like 952.

For Type 2A Configuration, even though there may be a variety of different role pairs in different questions and in different audioscripts, if the same role pair appears in different questions in the same audioscript, the voice corresponding to the same role indicator should be the same. Thus, it is not necessary to configure the same role pair repeatedly in each section-configuration, and all role pairs that appear in sections can be merged, after which all the role pairs are grouped into one Collection of Type 2A Configuration. In the Collection of Type 2A Configuration, there are multiple role pairs, each of which appears only once, and the UI implementation for each role pair can be referred to 954.

On the contrary, the Type 2B configuration is specific to the section. For example, the repeat count of each question that should be played back in a section can be different for different sections, and the silence time for students to answer the question is different for different sections. As a result, the Type 2B Configuration cannot be merged for different sections, but are available separately according to each section, and a UI implementation of Type 2B Configuration can be referred to 956.

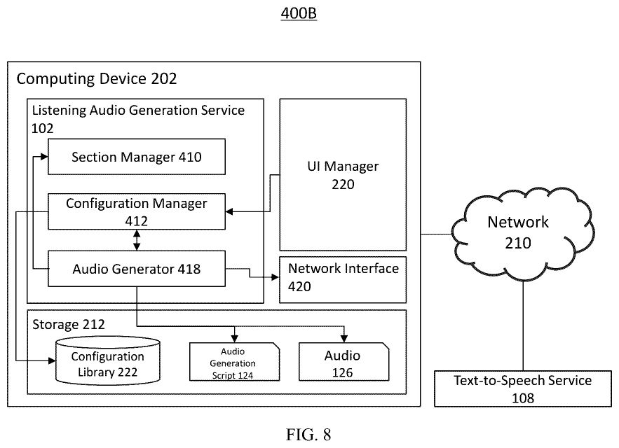

When the user clicks the Ok button 910, it means that the configuration is fulfilled and confirmed by the user. This user action triggers the processes of flowchart 300B. Referring back to FIG. 6, FIG. 6 shows a flowchart 300B providing a process for generating the complete audio and/or audio-generation-script corresponding to the audioscript. According to an example embodiment, flowchart 300B is described as follows with respect to FIG. 8.

In an embodiment, according to block 312, UI Manager 220 notifies Configuration Manager 412 that the user has already fulfilled and confirmed the configuration. If the configuration is not saved, an Auto Save event may be triggered in Configuration Manager 412 to save the configuration to Configuration Library 222. In an embodiment, when the configuration is saved, its additional information and/or metadata, such as the title of the configuration, tags, etc., are saved in the meantime. In an embodiment, the title of the configuration may be automatically generated based on the current time and/or user account information, etc.

In an embodiment, Configuration Manager 412 notifies Audio Generator 418 that the configuration has been fulfilled and confirmed, and then Audio Generator 418 obtains the array of sections from Section Manager 410 and the confirmed configuration from Configuration Manager 412. Audio Generator 418 then applies each section-configuration to the corresponding section node in turn, generating the audio and/or audio-generation-script of the section. In the process of generating audio, the Audio Generator 418 may call the Text-to-Speech Service 108 through Network Interface 420, to convert text to speech audio.

In an embodiment, according to block 314, When all the sections are processed, Audio Generator 418 concatenates all the audio and/or audio-generation-scripts in the order of sections to generate the complete audio 126 and/or audio-generation-script 124. In various embodiments, the audio 126 and/or audio-generation-script 124 may be saved to Storage 212. The LAGS 102 may transmit a URL, link, or other identifier of the audio 126 and/or the audio generation script 124 to the user client device 50 as a result. In various embodiments, the LAGS 102 may transmit the audio 126 and/or audio-generation-script 124 to the user client device 50 in flow, and will be save in the storage located in user client device 50.

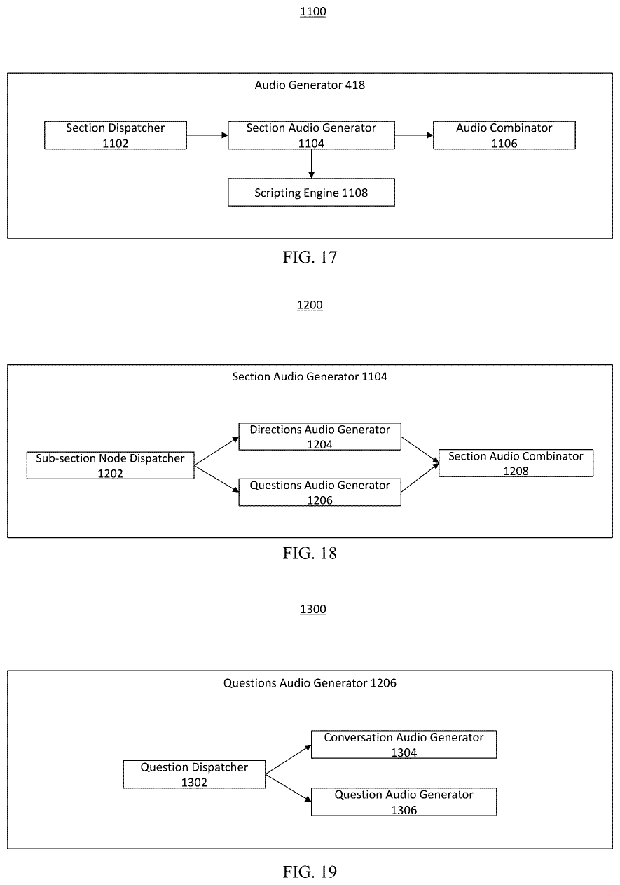

In an embodiment, FIG. 17 shows a block diagram of Audio Generator 418. In Audio Generator 418, Section Dispatcher 1102 dispatches each section node and its corresponding section-configuration to Section Audio Generator 1104, which applies the section-configuration to the section node and generates audio and/or audio-generation-script of the section. The Audio Combinator 1106 concatenates all the audio and/or audio-generation-scripts generated by each section in the order of sections to generate the complete audio and/or audio-generation-script of the audioscript.

In an embodiment, FIG. 18 shows a block diagram of Section Audio Generator 1104. In Section Audio Generator 1104, Sub-section Node Dispatcher 1202 dispatches each sub-section node 1022 in section node 1020 based on the type of sub-section node. If a sub-section node is a directions node, Sub-section Node Dispatcher 1202 will dispatch it to Directions Audio Generator 1204; If a sub-section node is a questions node, Sub-section Node Dispatcher 1202 will dispatch it to Questions Audio Generator 1206.

In an embodiment, Directions Audio Generator 1204 walks through each paragraph in the sub-section node, generates a “Text-to-Speech” script command for current paragraph to give the instruction how to generate audio according to its textual content in paragraph. Each script command generated has a sequence number/line number L, and the sequence number of the next generated script command is the current sequence number plus one. As an implementation, the “Text-to-Speech” script command may be in the form of Text_to_Speech(Text, SynthesisMode), in which “Text_to_Speech” is the command word, and the part in parentheses is a list of parameters. For this “Text_to_Speech” command, it has two parameters, the first parameter “Text” is the text content which needs to be converted into speech audio, and the second parameter “SynthesisMode” is the synthesis mode of the “Text”. According to the synthesis mode Bh in the first type of configuration in the corresponding section-configuration, the parameter of “SynthesisMode” on the directions content should be Bh. In the current example, Text_to_Speech (Text, Bh) is generated as the script command, and the parameter “Text” is the textual content of the paragraph. Furthermore, the script command generated can be executed by Scripting Engine 1108 to generate the corresponding audio. In an embodiment, Directions Audio Generator 1204 calls Scripting Engine 1108 to execute the script command. When this script command is executed, Scripting Engine 1108 calls Text-to-Speech Service 108 to convert “Text” to speech audio with synthesis mode Bh.

After the script command of Text_to_Speech, following a “Silence” script command generated by Directions Audio Generator 1204. As an implementation, the “Silence” script command is in the form of Silence (SilenceTime).

If the current paragraph is the last paragraph in the directions node, the script command of Silence (H2) is generated, according to the silence time H2 in the first type of configuration in the corresponding section-configuration. Furthermore, the script command generated can be executed by Scripting Engine 1108 to generate the corresponding audio. In an embodiment, Directions Audio Generator 1204 calls Scripting Engine 1108 to execute the script command. When this script command is executed, Scripting Engine 1108 generates a silenced audio with the length of H2 (seconds).

If the current paragraph is not the last paragraph in the current directions node, the script command of Silence (H1) is generated, according to the silence time H1 in the first type of configuration of the corresponding section-configuration.

In an embodiment, FIG. 19 shows a block diagram of Questions Audio Generator 1206. In Questions Audio Generator 1206, Question Dispatcher 1302 dispatches each question node in the questions node based on whether the question node contains a conversation. If the question node contains a conversation, Question Dispatcher 1302 dispatches the question node to Conversation Audio Generator 1304, otherwise Question Dispatcher 1302 dispatches the question node to Question Audio Generator 1306.

In an embodiment, Conversation Audio Generator 1304 walks through each part of the question node, and the question node with conversation looks like 1010. If the current part is a question number, Conversation Audio Generator 1304 generates a script command of Text_to_Speech (Text, Bn) according to the synthesis mode Bn in the second type of configuration in the corresponding section-configuration. And generates a script command of Silence (Q1), according to the silence time Q1 in the second type of configuration in the corresponding section-configuration.

If the current part is a role indicator, Conversation Audio Generator 1304 first obtain the synthesis mode Bd corresponding to the role indicator in the second type of configuration in the corresponding section-configuration, and then forward to the next part, that is, conversation content, to generate a script command of Text_to_Speech (Text, Bd), where the parameter of Text is conversation content.

If the question node is not finished (the current part is not the last part in the question node), Conversation Audio Generator 1304 generates a script command of Silence (Q2), according to the silence time Q2 in the second type of configuration in the corresponding section-configuration.

If the question node is finished (the current part is the last part of the question node), and the repeat count C is greater than one according to the second type of configuration, Conversation Audio Generator 1304 generates a “Repeat” script command. As an implementation, the “Repeat” script command is in the form of Repeat(X, Y, C), where X is the sequence number of the Text_to_Speech command corresponding to the first conversation content, and Y is the sequence number of the Text_to_Speech command corresponding to the last conversation content, and C is the repeat count. Furthermore, the script command generated can be executed by Scripting Engine 1108. In an embodiment, Conversation Audio Generator 1304 calls Scripting Engine 1108 to execute the script command. When this script command is executed, Scripting Engine 1108 repeats all the audio C times corresponding to the script command X to Y.

Conversation Audio Generator 1304 generates a script command of Silence (G) at the end of a question node, according to the silence time G in the second type of configuration in the corresponding section-configuration.

The script commands generated above can be further executed to generate the corresponding audio.

In an embodiment, Question Audio Generator 1306 walks through each part of the question node, and the question node with no conversation looks like 1012. If the current part is a question number, Question Audio Generator 1306 generates a script command of Text_to_Speech (Text, Bn) according to the synthesis mode Bn in the second type of configuration in the corresponding section-configuration. And generates a script command of Silence (Q1), according to the silence time Q1 in the second type of configuration in the corresponding section-configuration. If the current part is question content, Question Audio Generator 1306 generates a script command of Text_to_Speech(Text, Bc), according to the synthesis mode Bc in the second type of configuration in the corresponding section-configuration, where the parameter of Text is question content.

If the question is not finished (the current part is not the last part in the question node), Question Audio Generator 1306 generates a script command of Silence (Q2), according to the silence time Q2 in the second type of configuration in the corresponding section-configuration.

If the question node is finished (the current part is the last part of the question node), and the repeat count C is greater than one according to the second type of configuration, Question Audio Generator 1306 generate a script command of Repeat (X, Y, C), where X is the sequence number of the Text_to_Speech command corresponding to the first question content, and Y is the sequence number of the Text_to_Speech command corresponding to the last question content, and C is the repeat count.

Question Audio Generator 1306 generates a script command of Silence (G) at the end of a question node, according to the silence time G in the second type of configuration in the corresponding section-configuration.

The script commands generated above can be further executed to generate the corresponding audio.

In an embodiment, Section Audio Combinator 1208 concatenates all generated script commands to generate the audio-generation-script of the section, and/or concatenates all the audio generated by the execution of all the script commands, to generate the audio of the section.

In an embodiment, Audio Combinator 1106 concatenates all the audio-generation-scripts of each section, to generate the complete audio-generation-script, and/or concatenates all the audio of each section, to generate the complete audio.

### Example Embodiments

FIG. 20 is a block diagram of an example computing system for implementing example embodiments of Service 20 which can be LAGS 102, TCS 104 and/or PMS 106.

Note that one or more general-purpose or special-purpose computing systems/devices may be used to implement the Service 20. In addition, the computing system 10 may comprise one or more distinct computing systems/devices and may span distributed locations. Furthermore, each block shown may represent one or more such blocks as appropriate to a specific embodiment or may be combined with other blocks. Also, the Service 20 may be implemented in software, hardware, firmware, or in some combination to achieve the capabilities described herein.

In the embodiment shown, computing system 10 comprises a computer memory 11, a display 12, one or more Central Processing Units (“CPU”) 13, one or more GPU/TPU/NPU to accelerate the language model in TCS 104, input/output devices 15 (e.g., keyboard, mouse, LCD display, touch screen, and the like), computer-readable storage medium 16, other computer-readable media 17 and a network interface 18 for network connection.

The Service 20 is shown residing in memory 11. In other embodiments, some portion of the contents, some or all of the components of the Service 20 may be stored on and/or transmitted over the other computer-readable media 17. The components of the Service 20 preferably execute on one or more CPUs 13 and perform the processes described herein. Other code or programs 30 (e.g., an administrative interface, a Web server, and the like), and a data store 40, also reside in the memory 11, and preferably execute on one or more CPUs 13. Of note, one or more of the components in FIG. 20 may not be present in any specific implementation. For example, some embodiments may not provide other computer-readable media 17 or a display 12.

The illustrated example LAGS 102 may also interact with a user interface manager 220. The UI Manager 220 is shown in dashed lines to indicate that in other embodiments they may be provided by other, possibly remote, computing systems. The UI manager 220 provides a view and a controller that facilitate user interaction with the LAGS 102 and its various components. For example, the UI manager 220 may provide interactive access to the LAGS 102, such that users can upload audioscript for audio generation, set and review parameters in a configuration, download the final generated audio file or script file and the like. In some embodiments, access to the functionality of the UI manager 220 may be provided via a Web server, possibly executing as one of the other programs 30. In such embodiments, a user operating a Web browser (or other client) executing on the user client device 50 can interact with the LAGS 102 via the UI manager 220.

The LAGS 102 interacts via the network 210 with user client device 50, TCS 104, PMS 106 and third-party systems like Text-to-Speech Service 108. The network 210 may be any combination of one or more media (e.g., twisted pair, coaxial, fiber optic, radio frequency), hardware (e.g., routers, switches, repeaters, transceivers), and one or more protocols (e.g., TCP/IP, UDP, Ethernet, Wi-Fi, WiMAX) that facilitate communication between remotely situated humans and/or devices. In some embodiments, the network 210 may be or include multiple distinct communication channels or mechanisms (e.g., cable-based and wireless). The user client device 50 include personal computers, laptop computers, smart phones, personal digital assistants, tablet computers, kiosk systems, and the like. The user client device 50 may be or include computing systems and/or devices constituted in a manner similar to that of computing system 10, and thus may also include displays, CPUs, other I/O devices (e.g., a camera), network connections, or the like.

LAGS 102, TCS 104 and PMS 106 can be implemented in separate computing systems, or some of them can be combined on a single computer system or device. For example, TCS 104 and PMS 106 may be combined on a single server device, or LAGS 102 and PMS 106 may be combined on a single server device. And all of them combined on a single computer system or device is also possible. Furthermore, LAGS 102 and some of others can be combined with the user client device 50. For example, LAGS 102 may be combined with the user client device 50, or LAGS 102 and PMS 106 may be combined with the user client device 50. In this case, the UI manager 220 corresponding to LAGS 102 is equivalent to the user interface of the user client device 50.

In an example embodiment, components/modules of the Service 20 are implemented using standard programming techniques. For example, the LAGS 102 may be implemented as a “native” executable running on the CPU 13, along with one or more static or dynamic libraries. In other embodiments, the LAGS 102 may be implemented as instructions processed by a virtual machine that executes as one of the other programs 30. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The data store 40 may be implemented as one or more database systems, file systems, or any other technique for storing such information, or any combination of the above, including implementations using distributed computing techniques. In addition, some embodiments may provide one or more interfaces to the data stored as part of the Service 20. Such interfaces may be provided via database connectivity APIs accessed from a variety of programming languages, web-based interfaces, file systems interfaces, or the like.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in certain embodiments, some or all of the components of the Service 20 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored in a non-transitory manner on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

While the preferred embodiment of the invention has been illustrated and described, as noted above, many changes can be made without departing from the spirit and scope of the invention. Accordingly, the scope of the invention is not limited by the disclosure of the preferred embodiment.

It is claimed:

1. A computer-implemented method for automatically generating listening test audio from audioscript, comprising:
receiving, by one or more computing devices, the section-marked audioscript, managing the audioscript by sections, and parsing each section to a parsed state;
generating the corresponding section-configuration from each section, and combining all section-configurations into an audioscript configuration, or said, a configuration;
transmitting to a client device associated with a user, a graphical user interface (GUI) configured to display the configuration for the user to set and/or review the parameter values;
receiving, by one or more computing devices, the fulfilled and/or confirmed configuration, applying each section-configuration in configuration to the corresponding section, to generate the audio and/or audio-generation-script of the section; and
concatenating all the audio and/or audio-generation-script of each section to generate the complete audio and/or audio-generation-script of the audioscript.

2. The computer-implemented method of claim 1, wherein parsing each section to a parsed state comprises:
classifying by the language model, each paragraph in section is divided into two categories: Directions and Questions, by which split the section into directions content and questions content, for each paragraph in questions content, parsed further to question number, role indicator and question content (a specific paragraph may have only one or more of these three parts) by pattern matching, and splitting the questions content into a plurality of questions, based on question number.

3. The computer-implemented method of claim 1, wherein generating the section-configuration according to the corresponding section comprises:
generating the first type of configuration from directions content in the section, and initializing the parameter values to default values;
generating the second type of configuration from questions content in the section, and initializing the parameter values to default values; and
combining the first type of configuration and the second type of configuration to a section-configuration;

4. The computer-implemented method of claim 3, further comprising:
extracting visible parameter values from the paragraphs in directions content and questions content in section as preferred parameter values by pattern matching to override default values;

5. The computer-implemented method of claim 1, further comprising:
responsive to the configuration being generated, extracting features from audioscript, by one or more computing devices, as the tags of the audioscript, and as the tags of the configuration corresponding to the audioscript;
receiving, from the client device, the fulfilled and/or confirmed configuration; and
responsive to receiving the fulfilled and/or confirmed configuration, saving the configuration to a non-transitory computer readable storage medium for future reuse, and the tags saved along with the configuration as additional information and/or metadata of the configuration;
responsive to tags being generated, use the tags as the key to query whether the previously saved configurations match the current audioscript, and use the matching configurations as the reference configurations;
responsive to a reference configuration being selected, replacing the parameter values in the current configuration with the values from the user-selected preferred reference configuration for fast filling.

6. The computer-implemented method of claim 1, further comprising:
receiving a request to delete a specific configuration; and
responsive to the request, deleting the configuration.

7. The computer-implemented method of claim 1, wherein apply each section-configuration in configurations to the corresponding section, to generate the audio and/or audio-generation-script of the section comprises:
generating audio and/or audio-generation-script from directions content by applying the first type of configuration to each paragraph in the corresponding directions content;
generating audio and/or audio-generation-script from questions content by applying the second type of configuration to each part of a paragraph in the corresponding questions content; and
concatenating all the audio and/or audio-generation-script of directions content and questions content to generate the audio and/or audio-generation-script of the section.

8. A non-transitory computer readable storage medium comprising instructions that, when executed by a processing system, cause the processing system to perform the steps of:
receiving, by one or more computing devices, the section-marked audioscript, managing the audioscript by sections, and parsing each section to a parsed state;
generating the corresponding section-configuration from each section, and combining all section-configurations into an audioscript configuration, or said, a configuration;
transmitting to a client device associated with a user, a graphical user interface (GUI) configured to display the configuration for the user to set and/or review the parameter values;
receiving, by one or more computing devices, the fulfilled and/or confirmed configuration, applying each section-configuration in configuration to the corresponding section, to generate the audio and/or audio-generation-script of the section; and
concatenating all the audio and/or audio-generation-script of each section to generate the complete audio and/or audio-generation-script of the audioscript.

9. The non-transitory computer readable storage medium of claim 8, wherein parsing each section to a parsed state comprises:
classifying by the language model, each paragraph in section is divided into two categories: Directions and Questions, by which split the section into directions content and questions content, for each paragraph in questions content, parsed further to question number, role indicator and question content (a specific paragraph may have only one or more of these three parts) by pattern matching, and splitting the questions content into a plurality of questions, based on question number.

10. The non-transitory computer readable storage medium of claim 8, wherein generating the section-configuration according to the corresponding section comprises:
generating the first type of configuration from directions content in the section, and initializing the parameter values to default values;
generating the second type of configuration from questions content in the section, and initializing the parameter values to default values; and
combining the first type of configuration and the second type of configuration to a section-configuration;

11. The non-transitory computer readable storage medium of claim 10, wherein the steps further comprise:
extracting visible parameter values from the paragraphs in directions content and questions content in section as preferred parameter values by pattern matching to override default values;

12. The non-transitory computer readable storage medium of claim 8, wherein the steps further comprise:
responsive to the configuration being generated, extracting features from audioscript, by one or more computing devices, as the tags of the audioscript, and as the tags of the configuration corresponding to the audioscript;
receiving, from the client device, the fulfilled and/or confirmed configuration; and
responsive to receiving the fulfilled and/or confirmed configuration, saving the configuration to a non-transitory computer readable storage medium for future reuse, and the tags saved along with the configuration as additional information and/or metadata of the configuration;
responsive to tags being generated, use the tags as the key to query whether the previously saved configurations match the current audioscript, and use the matching configurations as the reference configurations;
responsive to a reference configuration being selected, replacing the parameter values in the current configuration with the values from the user-selected preferred reference configuration for fast filling.

13. The non-transitory computer readable storage medium of claim 8, wherein the steps further comprise:
receiving a request to delete a specific configuration; and
responsive to the request, deleting the configuration.

14. The non-transitory computer readable storage medium of claim 8, wherein apply each section-configuration in configurations to the corresponding section, to generate the audio and/or audio-generation-script of the section comprises:
generating audio and/or audio-generation-script from directions content by applying the first type of configuration to each paragraph in the corresponding directions content;
generating audio and/or audio-generation-script from questions content by applying the second type of configuration to each part of a paragraph in the corresponding questions content; and
concatenating all the audio and/or audio-generation-script of directions content and questions content to generate the audio and/or audio-generation-script of the section.

15. A system comprising:
one or more processors; and
one or more non-transitory computer readable storage mediums comprising instructions that, when executed by the one or more processors, cause the one or more processors to perform the steps of:
receiving, by one or more computing devices, the section-marked audioscript, managing the audioscript by sections, and parsing each section to a parsed state;
generating the corresponding section-configuration from each section, and combining all section-configurations into an audioscript configuration, or said, a configuration;
transmitting to a client device associated with a user, a graphical user interface (GUI) configured to display the configuration for the user to set and/or review the parameter values;
receiving, by one or more computing devices, the fulfilled and/or confirmed configuration, applying each section-configuration in configuration to the corresponding section, to generate the audio and/or audio-generation-script of the section; and
concatenating all the audio and/or audio-generation-script of each section to generate the complete audio and/or audio-generation-script of the audioscript.

16. The system of claim 15, wherein parsing each section to a parsed state comprises:
classifying by the language model, each paragraph in section is divided into two categories: Directions and Questions, by which split the section into directions content and questions content, for each paragraph in questions content, parsed further to question number, role indicator and question content (a specific paragraph may have only one or more of these three parts) by pattern matching, and splitting the questions content into a plurality of questions, based on question number.

17. The system of claim 15, wherein generating the section-configuration according to the corresponding section comprises:
generating the first type of configuration from directions content in the section, and initializing the parameter values to default values;
generating the second type of configuration from questions content in the section, and initializing the parameter values to default values; and
combining the first type of configuration and the second type of configuration to a section-configuration;

18. The system of claim 17, wherein the steps further comprise:
extracting visible parameter values from the paragraphs in directions content and questions content in section as preferred parameter values by pattern matching to override default values;

19. The system of claim 15, wherein the steps further comprise:
receiving, from the client device, the fulfilled and/or confirmed configuration; and
responsive to receiving the fulfilled and/or confirmed configuration, saving the configuration to a non-transitory computer readable storage medium for future reuse, and the tags saved along with the configuration as additional information and/or metadata of the configuration;
responsive to tags being generated, use the tags as the key to query whether the previously saved configurations match the current audioscript, and use the matching configurations as the reference configurations;
responsive to a reference configuration being selected, replacing the parameter values in the current configuration with the values from the user-selected preferred reference configuration for fast filling.

20. The system of claim 15, wherein apply each section-configuration in configurations to the corresponding section, to generate the audio and/or audio-generation-script of the section comprises:
generating audio and/or audio-generation-script from directions content by applying the first type of configuration to each paragraph in the corresponding directions content;
generating audio and/or audio-generation-script from questions content by applying the second type of configuration to each part of a paragraph in the corresponding questions content; and
concatenating all the audio and/or audio-generation-script of directions content and questions content to generate the audio and/or audio-generation-script of the section.
